(19) United States
(12) Patent Application Publication
(10) Pub. No.: US 2015/0105505 A1
(43) Pub. Date: Apr. 16, 2015

(54) Varnishes and Prepregs and Laminates Made Therefrom

(71) Applicant: Isola USA Corp., Chandler, AZ (US)

(72) Inventors: Guroen He, Chandler, AZ (US); Tarun Amla, Chandler, AZ (US)

(21) Appl. No.: 14/515,095

(22) Filed: Oct. 15, 2014

Related U.S. Application Data
(63) Continuation of application No. PCT/US14/60126, filed on Oct. 10, 2014.
(60) Provisional application No. 61/889,837, filed on Oct. 11, 2013.

(51) Int. Cl. C09D 171/02; C08K 5/03; C08K 5/5313

(52) U.S. Cl. CPC C09D 171/02; C08K 5/5313; C08K 5/03
USPC 524/119; 524/508; 524/117; 524/126

(57) ABSTRACT

Varnishes useful in manufacturing prepregs and laminates including at least one polymer selected from the group consisting of polyphenylene ether, polyphenylene oxide and combinations thereof; at least on reactive monomer; and at least one initiator.

This is a continuation of PCT/US2014/60126 filed on Oct. 10, 2014, which claims priority to U.S. provisional application No. 61/889,837, filed on Oct. 11, 2013, the specifications of each of which are incorporated herein by reference.

### BACKGROUND OF THE INVENTION

(1) Field of the Invention

This invention relates to varnish compositions used to make laminates and prepregs that are then used to manufacture printed circuit boards. This invention also is directed to laminates and prepregs made from the varnish compositions of this invention. The varnish compositions of this invention produce prepregs and laminates that possess excellent electrical performance suitable for high frequency application in electronics, as well as excellent thermal and mechanical performance and especially excellent peel strengths.

(2) Description of the Art

With operating frequencies of electronic devices ever increasing, the dielectric constant (DK) and dielectric dissipation factor (DF) of the resin substrate used in the printed circuit boards associated with the electronic devices is becoming more important. The lead-free technology in soldering process driven by tighter and tighter environment restriction also requires better thermal stability of the resin substrate. Traditional thermosetting resin systems like phenolic resins and epoxy resins are beginning to show the limitations when incorporated into high dielectric constant and/or high dielectric dissipation factor electronic substrates.

Resins useful in the manufacture of printed circuit boards are disclosed, for example in the following U.S. Pat. Nos. 5,218,030, 5,223,568, 5,571,609, 6,306,963, 6,352,783, 6,617,398 and 7,090,924. Some of the listed patents disclose technology which can produce low DF materials but usually has low Tg and high thermal expansion (although may not be mentioned in the patent). This kind of materials can be used only on double sided or only few layers laminates for high frequency application, like antennas. Some patents disclose technology that can produce a material with high Tg, while their DF is not low enough for very high frequency application. Others disclose technologies that are useful in preparing good final performance products but cannot be used to make dry B-stage glass prepreg for most PCB manufacturers.

The trend of the electronics industry requires materials not only with low DK and DF for high frequency application, but also good mechanical and thermal properties for multilayer board application. High Tg low thermal expansion and good thermal stability are primary importance for multilayer board application. Therefore, a need continues to exist for thermosetting resin compositions that are useful in manufacturing prepregs and laminates with excellent electrical performance for high frequency application while retaining desirable thermal and mechanical performance like high Tg, low CTE, high thermal stability, as well as low process temperature and being able to make non-sticky, non-tacky B-stage prepreg for conventional multi-layer board fabrication.

### SUMMARY OF THE INVENTION

The present invention is directed to compounded varnishes made with synthesized base resins or with commercially available raw resins and prepregs and laminates made from the compounded varnishes.

In one aspect, this invention includes varnish compositions comprising: a polymer selected from the group consisting of polyphenylene ether, polyphenylene oxide and combinations thereof; at least on reactive monomer; and at least one initiator.

Another aspect of this invention includes varnish compositions comprising: from about 30 to about 60 wt % of at least one polyphenylene oxide polymer having the following formula:

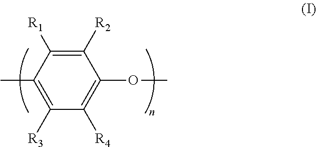

where R₁, R₂, R₃ and R₄ may be individually selected from hydrogen and a C₁ to C₄ alkyl group wherein n is an integer ranging from 1 to 100; from about 15 to about 35 wt % triallyl cyanurate; from about 0.5 to about 3 wt % of at least one initiator selected from the group consisting of benzoyl peroxide, dicumyl peroxide, 2,5-Dimethyl-2,5-di-t-butylperoxyhexyne, 2,5-Dimethyl-2,5-di-t-butylperoxyhexane and combinations thereof;

from about 5 to about 50 wt % of at least one flame retardant selected from

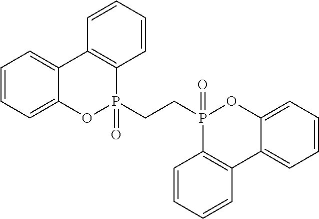 [SMILES: O=P1(CCP2(=O)Oc3ccccc3-c3ccccc32)Oc2ccccc2-c2ccccc21]

and decabromodiphenyl ethane; and from greater than 0 to about 30 wt % of at least one silica filler.

Still another aspect of this invention are prepregs, laminates, and resin coated copper sheets manufactured using the varnishes of this invention.

### DESCRIPTION OF CURRENT EMBODIMENTS

This invention is directed generally to varnishes made from a plurality of ingredients as well as to prepregs and laminates made using the varnishes of this invention.

Varnishes of this invention are made by a “compounding” process where a resin ingredient is combined with other ingredients to form a thermosetting varnish. The varnish is then used to manufacture a laminate. The varnish can be used to manufacture a laminate by “impregnating” a core material such as a woven glass fabric with the varnish. Alternatively, the varnish can be used to coat a copper sheet to form a resin coated copper sheet in which the resin is partially or fully cured. In another aspect of this invention, the varnish can be used to form a prepreg or laminate sheet that does not have a core material. The products made from the varnishes of this invention are useful as a prepreg—i.e., a product in which the varnish has been partially cured or “b-staged”. The products made from the varnishes of this invention are also useful where the varnish is in a completely cured or “c-staged” form. The ingredients used to formulate the varnishes of this invention are discussed in more detail below. Unless stated otherwise, the composition ingredient weight percent ranges and varnish ingredient weight percent ranges are reported on a “dry”—solvent free basis.

The ingredients and optional ingredients of varnishes useful in the present invention are discussed in more detail below.

### Polyphenylene Ether (PPE)/Polyphenylene Oxide (PPO)

A first ingredient of the varnishes of this invention is polyphenylene ethers or polyphenylene oxide polymers. Polyphenylene ether and polyphenylene oxide refers to the same general composition having the following formula:

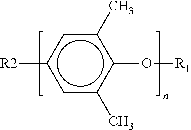

where the terminal groups—R₁ and R₂ can be hydrogen, methacrylate or acrylate group and wherein n is an integer ranging from 1 to 100 and preferably from 1 to 50. When the molecular weight of PPE is lower than 5000, it can be directly added into the varnish at room temperature. When PPE or PPO have molecular weight is higher than 5000, the varnish may need to be heated to 50° C. or higher to dissolve it. Polyphenylene oxide has the following general formula:

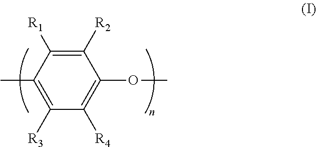

Where R₁, R₂, R₃ and R₄ may be individually selected from an alkyl group, preferably a C₁ to C₄ alkyl while the terminal groups may be any low electronegative end group including, but not limited to OH, methacrylate or acrylate with methacrylate being a preferred end group. In the composition above, n is an integer ranging from 1 to about 100 and preferably 1 to 50.

A preferred polyphenylene oxide is

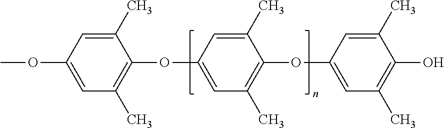

Yet another preferred polyphenylene oxide is:

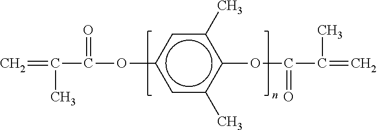

where n is an integer ranging from 1 to about 100 and more preferably 1 to 50.

The molecular weight of PPO used in varnishes of this invention may range from about 1000 to about 5000 or more. Additional examples of useful PPOs and PPEs can be found in U.S. Pat. No. 6,897,282 the specification of which is incorporated herein by reference.

PPE or PPO will typically be included in the varnishes of this invention in an amount ranging from about 25 to about 75 wt %. More preferably PPE/PPO may be present as an ingredient of a compounded varnish in an amount ranging from about 30 to about 60 wt %.

### Reactive Monomers

The varnish compositions of this invention may include one or more reactive monomers. The reactive monomer(s) may be any monomer that contains one or more carbon-carbon double bonds that can react with the unsaturated polyolefin resin. Suitable chemical reactivity is the first consideration. Examples of useful reactive monomers include styrenic monomers such as styrene, bromo-styrene, dibromostyrene, divinylbenzene, pentabromobenzyl acrylate, trivinylcyclohexane, triallyl isocyanurate, triallyl cyanurate, triacrylate isocyanurate and combinations thereof.

In some case, if the reactive monomer includes bromine, the reactive monomer can be used as a portion to all of the composition flame retardant. For example, bromo-styrene, dibromostyrene and pentabromobenzyl acrylate are all flame retardant candidates. These reactive monomers can, therefore, be used in the varnishes of this invention as a reactive monomer, as a flame retardant or as both.

The reactive monomer(s), if used, will typically be present in the varnish composition in an amount ranging from about greater than 0 to about 40 wt %, or from about 15 to about 35 wt % and more narrowly from about 15 to about 25 wt %.

### Flame Retardants

The compounded varnishes of this invention may include one or more flame retardants. Any flame retardant that is known to be useful in resin compositions used to manufacture composites and laminates use to manufacture printed circuit boards may be used. The flame retardants may contain halogens or they may be halogen free. Examples of useful flame retardants include, but are not limited to, halides of glycidyl etherified bifunctional alcohols, halides of novolac resins such as bisphenol A, bisphenol F, polyvinylphenol or phenol, creosol, alkylphenol, catecohl, and novolac resins such as bisphenol F, inorganic flame retardants such as antimony trioxide, red phosphorus, zirconium hydroxide, barium metaborate, aluminum hydroxide, and magnesium hydroxide, and phosphor flame retardants such as tetraphenyl phosphine, tricresyl-diphenyl phosphate, triethylphosphate, cresyldiphenylphosphate, xylenyl-diphenyl phosphate, acid phosphate esters, ammonia phosphate, ammonia polyphosphate, ammonia cyanurate, phosphate compounds containing nitrogen, and phosphate esters containing halides.

The phosphor flame retardants may include, for example, 9,10-Dihydro-9-oxa-10 phosphaphenanthrene-10-oxide (DOPO) having the following formula:

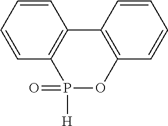 [SMILES: O=[PH]1Oc2ccccc2-c2ccccc21]

and derivatives thereof such as:

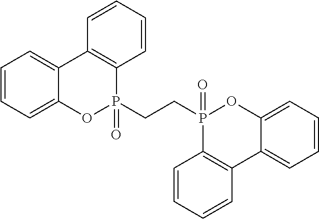 [SMILES: O=P1(CCP2(=O)Oc3ccccc3-c3ccccc32)Oc2ccccc2-c2ccccc21]

and a flame retardant having the following formula:

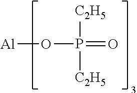

Still other useful halogen free flame retardants based upon phosphorous can include, for example, compounds in which phosphorous is present as a phosphate compound, e.g., a monophosphate, diphosphate, triphosphate, bis-phosphate, tris-phosphate, etc. In certain other examples, the phosphorous is present as a phosphonate compound. Additional suitable compounds that include one or more phosphorous atoms will be readily selected by the person of ordinary skill in the art, given the benefit of this disclosure. In certain examples, the phosphorous originates from phosphorated chemicals, e.g., inorganic and organic phosphates. For example, in certain examples, the phosphorated compound has a formula as shown below in formulae (III)-(VI).

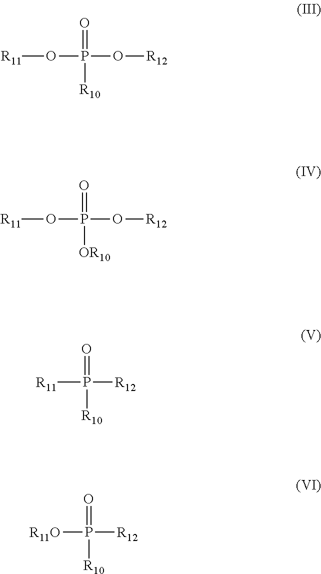

In formulae (III)-(VI), R₁₀, R₁₁ and R₁₂ each may be independently selected from the group consisting of alkyl, aryl, and alicyclic and heterocyclic groups that include nitrogen, oxygen and/or phosphorous. In certain examples, R₁₀, R₁₁, R₁₂ each is independently selected from primary or secondary lower alkyl (e.g., C1-C7 alkyl), primary or secondary lower alkenyl, (e.g. C2-C7 alkenyl), primary or secondary lower alkynyl (e.g., C2-C7 alkynyl), aryl, and alicyclic and heterocylic groups that include nitrogen, oxygen and phosphorous.

Exemplary commercially available materials that can be used to provide the source of phosphorous include, but are not limited to, ammonia polyphosphates such as Exolit® APP-422 and Exolit® APP-423 (commercially available from Clariant (Germany)), Arafil-72 and Arafil-76 (commercially available from Huntsman (Salt Lake City, Utah)) and Antiblaze® MC (commercially available from Albemarle (Baton Rouge, La.)), melamine polyphosphates such as Melapurg-200 and Melapurg-MP (commercially available from Ciba (Switzerland) and Fyrol(V-MP (commercially available from Akzo Nobel (Chicago, Ill.)), and organic phosphonates such as OP-930 and OP-1230 (commercially available from Clariant (Germany)). Other suitable phosphorous containing compounds, such as ammonium phosphates, ammonium polyphosphates, melamine phosphates, melamine polyphosphates, red phosphorus other organic and nitroorganic phosphorous compounds will be readily selected by the person of ordinary skill in the art, given the benefit of this disclosure.

In yet another aspect of this invention, the flame retardant may be a reactive phosphorous containing monomer. On class of useful reactive phosphorous containing monomers has the following general formula:

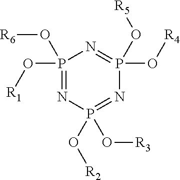

Wherein R₁ to R₆ are each independently selected from hydrogen, alkyl, alkenyl, aryl and derivatives thereof with each having from 1 to 12 carbon atoms. For example, R can be an allyl group:

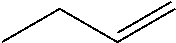

or an allyl phenyl group:

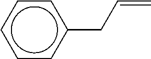

or a styrenic group:

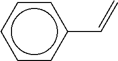

In one preferred embodiment, the flame retardant is the solid flame retardant decabromodiphenylethane, which has the following structure:

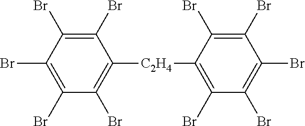

Decabromodiphenylethane is commercially available, for example, from Albemarle Corporation (451 Florida St., Baton Rouge, La. 70801). The Albemarle product is sold as Saytex™ 8010. Decabromodiphenylethane also unexpectedly improves the dielectric properties of the cured resin composition. As a result, decabromodiphenylethane can be included in the resin compositions in amounts far greater than is necessary for a flame retardant in order to also enhance the dielectric properties of the cured resin. Another useful high bromine content insoluble flame retardant is ethylenebistetrabromophthalimide which is sold as Saytex BT93W by Albemarle Corporation. Other similar useful flame retardants include decabromodiphenyl oxide and brominated polystyrene.

Solid flame retardants, such as Saytex 8010, etc. can create varnish formulation and use issues. Some potential issues with using a solid “filler-type” flame retardant include poor penetration into glass fiber bundles, poor via filling, lower peel strength, etc. We have discovered that one way to avoid some of these issues is to use a reactive and solvent soluble brominated flame retardant. Examples of such reactive and soluble brominated flame retardants include pentabromobenzyl acrylate, dibromostyrene, bromo-styrene and mixtures thereof.

As noted above, dibomostyrene (DBS) is a useful reactive and solvent soluble flame retardant. However handling DBS is difficult. In one aspect of this invention, the flame retardant is a co-polymer of the reactive flame retardant and the reactive monomer. For example, one useful ingredient of varnishes of this invention is a copolymer of DBS and TAC which, when combined with other varnish ingredients effectively fixes DBS in the resin matrix and so greatly reduce the level of free DBS. It is noted that the copolymer should be synthesized before the copolymer is admixed with other ingredients to form the varnishes of this invention. Using this copolymer as reactive flame retardant gives a non-filled product with good performance. In used, the copolymer will be present in the varnish in an amount ranging from about 15 to about 60 wt %.

The one or more flame retardants will be present in the varnish compositions of this invention in an amount sufficient to allow laminates made from the varnish compositions to pass the UL-94 flammability test. In general, the one or more flame retardants or combinations thereof may be present in the varnishes of this invention in an amount ranging from about 5% to about 50%, or from about 20% to about 45% on a dry weight basis.

### Initiators/Catalysts

Either peroxide or azo-type polymerization initiators (catalysts) can be used in in the resin compositions to perform a variant of functions such as encouraging homopolymerization and/or crosslinking varnish ingredients and to be available during varnish thermosetting to enhance the rate of resin cure. The initiators/catalysts chosen may be any compound that is known to be useful in resin synthesis or curing whether or not it performs one of these functions.

On example of useful initiators are peroxide compounds. Suitable peroxide initiators include, for example benzoyl peroxide (BPO) and dicumyl peroxide (dicup) 2,5-Dimethyl-2,5-di-t-butylperoxyhexyne (DYBP), and 2,5-Dimethyl-2,5-di-t-butylperoxyhexane. Another class of useful initiators is azo-type initiators such as azobisisobutyronitrile (AIBN).

The amount of initiator used depends upon its application. When used in a varnish, the initiator will be present in an amount ranging from about 0.5 to about 3.0 wt %.

In an alternative embodiment, the initiator is present in the varnish in an amount ranging from about 1% to 2% based upon 100% of reactive component. By “reactive component” we mean an amount of peroxide is based on 100 parts of reactive component, such as PPO+TAO and not including non-reactive components such as inorganic fillers, non-reactive flame retardant, etc.

### Solvents

One or more solvents are typically incorporated into the varnish compositions of this invention in order to solubilize the appropriate varnish composition ingredients, and or to control varnish viscosity, and/or in order to maintain the ingredients in a suspended dispersion. Any solvent known by one of skill in the art to be useful in conjunction with thermosetting resin systems can be used. Particularly useful solvents include methylethylketone (MEK), toluene, dimethylformamide (DMF), or mixtures thereof.

When used, solvents are present in the varnish in an amount of from about 20% to about 50% as a weight percentage of the total weight of the composition.

### Optional Ingredients

(a) Fillers

One or more fillers can optionally be added to the resin compositions of this invention to improve mechanical, chemical and electrical properties of the cured resin. Examples of properties that can be modified with fillers include, but are not limited to, coefficient of thermal expansion, increasing modulus, and reducing prepreg tack. Non-limiting examples of useful fillers include particulate forms of Teflon®, Rayton®, talc, quartz, ceramics, particulate metal oxides such as silica, titanium dioxide, alumina, ceria, clay, boron nitride, wollastonite, particulate rubber, PPO/PolyPhenylene Oxide and mixtures thereof. Preferred fillers include calcined clay, fused silica and combinations thereof. Yet other preferred fillers are silane treated silica and reclassified silica. When used, fillers are present in the compounded varnish of this invention in an amount from greater than 0% to about 40 wt %, preferably from greater than 0 to about 30 wt %, based on the cumulative dry weight or solvent free weight of the varnish ingredients.

(b) Tougheners

The thermosetting resin compositions of this invention may include one or more tougheners. The tougheners are added to the resin compositions to improve the drillability of the resulting composites and laminates. Useful tougheners include methyl methacrylate/butadiene/styrene copolymer, methacrylate butadiene styrene core shell particles, and mixtures thereof. A preferred toughener is methacrylate butadiene styrene core shell particles, which is available from Rohm & Haas (100 Independence Mall West, Philadelphia, Pa.), sold under the trade name Paraloid®. When used, tougheners are present in the thermosetting resin compositions of this invention in an amount from about 1% to about 5%, preferably from about 2 to about 4%, based on 100% by weight solids of the composition.

(c) Adhesion Promoters

To improve the adhesion of the resin to copper foil, other optional monomers can be added into the synthesis or into the varnish during compounding. Such monomers are unsaturated functional monomers including those containing urethane, amino or urea groups such as:

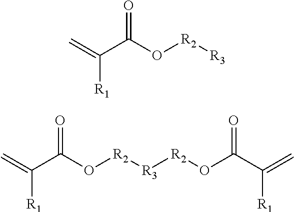

where R₁ can be H or C₁ to C₃ alkyl group, R₂ can be C₁ to C₄ alkyl group and R₃ can be one or more urethane group, amino group or urea group, such as diurethane dimethacrylate, dimethylaminoethyl methacrylate or methacrylamide, etc.

When adhesion promoters are incorporated into the compounded varnish, they will be present in an amount ranging from about 1 to about 20 wt % and more narrowly for about 5 to about 10 wt % on a dry basis.

(d) Other Optional Ingredients

Optionally, the compounded varnish may also contain other additives such as defoaming agents, leveling agents, dyes, and pigments. For example, a fluorescent dye can be added to the resin composition in a trace amount to cause a laminate prepared therefrom to fluoresce when exposed to UV light in a board shop's optical inspection equipment. A useful fluorescent dye is a highly conjugated diene dye. One example of such a dye is UVITEX® OB (2,5-thiophenediylbis(5-tert-butyl-1,3-benzoxazole), available from Ciba Specialty Chemicals, Tarrytown, N.Y.

Other optional ingredients known by persons of skill in the art to be useful in resins that are used to manufacture printed circuit board laminates may also be included in the resin compositions of this invention.

### Prepregs and Laminates

The varnishes described above are useful for preparing prepregs and/or laminates used to manufacture printed circuit boards. In order to be useful in manufacturing printed circuit boards the laminates can be partially cured or b-staged in which state they can be laid up with additional material sheets and pressed under pressure and temperature to form a multilayer c-staged or fully cured laminate sheet. Alternatively, the varnishes can be used in the manufacture of individual c-staged or fully cured material sheets.

In one useful processing system, the varnish compositions of this invention are useful for making prepregs in a batch or in a continuous process. Prepregs are generally manufactured using a core material such as a roll of woven glass web (fabric) which is unwound into a series of drive rolls. The web then passes into a coating area where the web is passed through a tank which contains the thermosetting varnishes of this invention, solvent and other components where the glass web becomes saturated (impregnated) with the varnish. The varnish saturated glass web is then passed through a pair of metering rolls which remove excess varnish from the saturated glass web and thereafter, the varnish coated web travels the length of a drying tower for a selected period of time until the solvent is evaporated from the web. A second and subsequent coating of varnish can optionally be applied to the web by repeating these steps until the preparation of the prepreg is complete whereupon the prepreg is wound onto roll The woven glass web can replaced with a woven fabric material, paper, plastic sheets, felt, and/or particulate materials such as glass fiber particles or particulate materials.

In another process for manufacturing prepreg or laminate materials, thermosetting varnishes of this invention are premixed in a mixing vessel under ambient temperature and pressure. The viscosity of the pre-mix can vary but is preferably ˜600-1000 cps and can be adjusted by adding or removing solvent from the resin. Fabric substrate (typically but not limited to E glass) is pulled through a dip tank including the premixed varnish, through an oven tower where excess solvent is driven off and the prepreg is rolled or sheeted to size, layed up between Cu foil in various constructions depending on glass weave style, resin content & thickness requirements.

The thermosetting varnish (resin) mix can also be applied in a thin layer to a Cu foil substrate (RCC—Resin Coated Copper) using slot-die or other related coating techniques.

The varnishes, prepregs and resin coated copper foil sheets described above can be used to make laminates in batch or in continuous processes. In exemplary continuous process for manufacturing laminates of this invention, a continuous sheet in the form of each of copper, a prepreg and a thin fabric sheet are continuously unwound into a series of drive rolls to form a layered web of fabric, adjacent to the resin prepreg sheet which is adjacent to a copper foil sheet such that the prepreg sheet lies between the copper foil sheet and the fabric sheet The web is then subjected to heat and pressure conditions for a time that is sufficient to cause the varnish to migrate into the fabric material and to completely cure the varnish. In the resulting laminate, the migration of the varnish material into the fabric causes the thickness of the resin layer (the distance between the copper foil material and the fabric sheet material to diminish and approach zero as combination layers discussed above transforms from a web of three layers into a single laminate sheet. In an alternative to this method, a single prepreg sheet can be applied to one side of the fabric material layer and the combination sandwiched between two copper layers after which heat and/or pressure is applied to the layup to cause the varnish material to flow and thoroughly impregnate the fabric layer and cause both copper foil layers to adhere to the central laminate.

In still another embodiment, the resin coated copper sheets can be made at the same time the laminate is being made by applying a thin coating of varnish to two different continuously moving copper sheets, removing any excess varnish from the sheets to control the resin thickness and then partially curing the varnish under heat and/or pressure conditions to form a sheet of b-staged resin coated copper. The sheet(s) of b-staged resin coated copper can then be used directly in the laminate manufacturing process.

In yet another embodiment, the fabric material—with or without prior pretreatment—can be continuously fed into a varnish bath such that the fabric material becomes impregnated with the varnish. The varnish can be optionally partially cured at this stage in the process. Next, one or two copper foil layers can be associated with the first and/or second planar surface of the varnish impregnated fabric sheet to form a web after which heat and/or pressure is applied to the web to fully cure the varnish to form a copper clad laminate.

### Example 1

Laminates were prepared from 2116 glass cloth using the two varnish formulations of this invention and electrical and mechanical properties of the laminates were determined. The varnish was applied to 2116 glass cloth in a treater at a varnish temperature of from about 300-320° F. and allowed to remain in the treater for from about 3-5 min. and then partially cured.

A layup including six layers of partially cured varnish impregnated woven glass cloth and copper foil on the outside surface(s) was prepared and the combination was fully cured in a press operating at a temperature of about 370-390° F. and a pressure of about 300 psi for 90-120 min. to form a fully cured copper clad laminate. The cured varnish coated glass sheet material had a resin (varnish) content of from about 51-53 wt %—the remainder being the weight of the woven glass cloth.

The varnishes used and the test results are reported in the Tables 1-3 below.

TABLE 1
Varnish Formula A

| Component | Component Weight | Solid weight % |
|---|---|---|
| Polyphenylene oxide | 35 | 52 |
| Triallyl cyanurate | 18 | 27 |
| Saytex 8010 | 13 | 20 |
| Dicumyl peroxide | 0.53 | 0.8 |
| Toluene | 29 | |
| Dimethylformamide | 4 | |
| Total | 100 | 100 |

TABLE 2
Varnish Formula B

| Component | Component Weight | Solid weight % (dry) |
|---|---|---|
| Polyphenylene oxide | 33 | 49 |
| Triallyl cyanurate | 17 | 25 |
| XP7866 | 16 | 25 |
| Dicumyl peroxide | 0.50 | 0.75 |
| Toluene | 30 | |
| Dimethylformamide | 4 | |
| Total | 100 | 100 |

Note:
XP-7866 is a halogen-free flame retardant.

TABLE 3
Laminate Physical Properties

| Properties | | Unit | Varnish A | Varnish B |
|---|---|---|---|---|
| Tg by DMA | | ° C. | 200~210 | 200~210 |
| DK | 10 GHz | | 3.3~3.5 | 3.5~3.7 |
| DF | 10 GHz | | 0.0030~0.0035 | 0.0035~0.0045 |
| T-288 | | Min | 60 | 60 |
| CTE | (20~288° C.) | ppm/° C. | 65~75 | 60~70 |
| Z % | (50~250° C.) | % | 3.2~3.5 | 2.7~3.3 |
| expansion | | | | |
| Peel strength | 0.5 oz | Lb/in | ~4.5 | ~4.0 |
| | reverse | | | |
| | treated | | | |
| | 1 oz reverse | | ~5.5 | ~5.5 |
| | treated | | | |
| | VLP-2-1 Oz | | ~5.8 | ~4.5 |
| | VLP- | | ~4.7 | ~5.8 |
| | 2-½ Oz. | | | |
| Solder float | | Second | [symbol] 1000 | [symbol] 1000 |
| time to | | | | |
| failure | | | | |
| Flammability | | | UL V-0 | UL V-0 |

### Example 2

This example evaluated two varnish compositions of this invention wherein the first varnish composition (composition C) included triallyl isocyanurate as the reactive monomer the second varnish composition (composition D) included triallyl cyanurate as the reactive monomer. Both varnish compositions were used to form a laminate in accordance with the method described in Example 1. Each laminate was evaluated for DF and copper peel strength. The varnish compositions and physical properties are reported in Table 4 below.

TABLE 4

| | C | D |
|---|---|---|
| PPO | 66 | 66 |
| TAC | 34 | |
| TAIC | | 34 |
| Saytex | 30 | 30 |
| 8010 | | |
| Dicup | 2 | 2 |
| DF | 0.0055 | 0.0077 |
| Peel | 5.6 | 4.6 |

The DF and peel strength of laminates prepared by varnishes C and D indicate that varnish D, including triallyl cyanurate has a lower DF and better peel strengths in comparison to the laminate made with varnish D and including triallyl isocyanurate as the reactive monomer.

### Example 3

This example evaluated the physical properties of laminates made with varnish compositions including increasing amounts of the peroxide initiator 2,5-Di(tert-butylperoxy)-2,5-dimethyl-3-hexyne (DYBP) on laminate DF. Varnish compositions E-I were used to form a laminate in accordance with the method described in Example 1. The laminates prepared from varnishes E-I were evaluated for DF. The varnish compositions and DF are summarized in Table 5 below.

TABLE 5

| | E | F | G | H | I |
|---|---|---|---|---|---|
| PPO | 50 | 50 | 50 | 50 | 50 |
| TAC | 25 | 25 | 25 | 25 | 25 |
| Flame | 30 | 30 | 30 | 30 | 30 |
| retardant | | | | | |
| DYBP | 6 | 5 | 4 | 3 | 2 |
| DYBP % of | 3.0 | 2.5 | 2.0 | 1.5 | 1.0 |
| Reactive | | | | | |
| Component | | | | | |
| DF | 0.0083 | 0.0072 | 0.0064 | 0.0060 | 0.0051 |

The data indicates that the loading of peroxide has a significant impact of DF. A 1% loading appears the best. Lower than 1% or higher than 2% will give unacceptable DF performance. (Note: here 1% or 2% is based on 100% of reactive component (PPO), not the total solid)

### Example 4

This example evaluated the impact of the ratio of the weight amount of PPO to the weight amount of triallyl cyanurate in a varnish on T-260, T28 and 50-250 expansion properties. Varnish compositions J to N were formulated and included PPO and TAO in the weight ratios reported below. In addition, each varnish included the following ingredients and amounts: PPO and TAO total 100 parts; brominated flame retardant—25 parts; peroxide 1 part. Varnish compositions J-N were used to form a laminate in accordance with the method described in Example 1. The laminates prepared using each of varnishes J-N were evaluated for expansion at different conditions. The varnish compositions and expansion results are summarized in Table 6 below.

TABLE 6

| | J | K | L | M | N |
|---|---|---|---|---|---|
| PPO:TAC | 2 | 2.3 | 3 | 4 | 5 |
| Expansion in T-260 | 2.8 | 2.9 | 3.9 | 4.7 | 4.9 |
| test (%) | | | | | |
| Expansion in T-288 | 5.2 | 5.3 | 7.0 | 8.8 | 7.5 |
| test (%) | | | | | |
| Expansion in 50-250 C. | 2.9 | 3.2 | 3.3 | 3.5 | 3.6 |
| (%) | | | | | |

It is apparent from Table 6 that the PPO:TAC ratio has an impact on laminate properties such as thermal expansion. Higher expansion of PPO/TAC gives higher thermal expansion. The ratio of PPO:TAC also affects resin flowability. Higher ratios give lower resin flowability and thus poorer prepreg quality. Thus, a PPO:TAC ratio of from about 1 to 3 provides the best overall results.

### Example 5

This example evaluated the impact of the flame retardant selection on laminate physical properties. Varnish compositions O and P were formulated with varnish 0 including a copolymer of DBS/TAC as the flame retardant and varnish P including Saytex 8010 (decabromodiphenylethane)—a solid insoluble flame retardant. Each varnish included Varnish composition 0 included 29 wt % of a copolymer of DBA/TAC, while varnish P included 20 wt % Saytex 8010 (decabromodiphenyl ethane). The other ingredients of varnishes O and P included PPO/TAC at a ratio of 2:1 and 1% peroxide.

Varnish compositions O and P were used to form a laminate in accordance with the method described in Example 1. The laminates prepared using each of varnishes 0 and P were evaluated for peel, expansion at 288° C., for Tg and for DF. The varnish compositions and expansion results are summarized in Table 7 below.

TABLE 7

| | Copolymer | |
|---|---|---|
| | of | Saytex |
| Flame retardant | DBS/TAC | 8010 filler |
| Peel | 4.6 | 4.1 |
| Expansion in T-288 | 5.7 | 6.6 |
| test | | |
| Tg by DMA | 214 | 219 |
| DF | 0.0039 | 0.0041 |

The laminate physical properties in Table 7 above demonstrate that laminates in which the flame retardant is a copolymer of DBS/TAC have certain physical properties that are equal to or better than laminates prepared using the inert solid flame retardant Saytex 8010.

### Example 6

This example evaluated the impact of the flame retardant selection on laminate physical properties. Varnish compositions Q and R were formulated with varnish Q including a phosphate-based flame retardant and varnish R including Saytex 8010 (decabromodiphenylethane)—a solid insoluble flame retardant. The varnish formulations are reported in Tables 8-9 below.

TABLE 8
Halogen-Free Formula (Q)

| | Component | |
|---|---|---|
| Component | Weight | Solid weight % |
| Polyphenylene | 33 | 49 |
| oxide | | |
| Triallyl cyanurate | 17 | 25 |
| DOPO derivative | 16 | 25 |
| Dicumyl peroxide | 0.50 | 0.75 |
| Toluene | 30 | |
| Dimethylformamide | 4 | |
| Total | 100 | 100 |

TABLE 9
Brominated Formula (R)

| | Component | |
|---|---|---|
| Component | Weight | Solid weight % |
| Polyphenylene | 35 | 52 |
| oxide | | |
| Triallyl cyanurate | 18 | 27 |
| Saytex 8010 | 13 | 20 |
| Dicumyl peroxide | 0.53 | 0.8 |
| Toluene | 29 | |
| Dimethylformamide | 4 | |
| Total | 100 | 100 |

TABLE 10
Laminate Performance

| Properties | | Unit | Varnish Q | Varnish R |
|---|---|---|---|---|
| Tg by DMA | | ° C. | 200~210 | 200~210 |
| DK | 10 GHz | | 3.5~3.7 | 3.3~3.5 |
| DF | 10 GHz | | 0.0035~0.0045 | 0.0030~0.0035 |
| T-288 | | Min | 60 | 60 |
| Z % | (50~250° C.) | % | 2.7~3.3 | 3.2~3.5 |
| expansion | | | | |
| Peel strength | 0.5 oz | Lb/in | ~4.0 | ~4.5 |
| | reverse | | | |
| | treated | | | |
| | 1 oz reverse | | ~5.5 | ~5.5 |
| | treated | | | |
| | VLP-2-1 Oz | | ~4.5 | ~5.8 |
| | VLP-2-½ Oz. | | ~5.8 | ~4.7 |
| Solder float | | Second | [symbol] 1000 | [symbol] 1000 |
| time to | | | | |
| failure | | | | |
| Flammability | | | UL V-0 | UL V-0 |

The laminate performance data reported in Table 10 above indicates that laminates prepared from varnishes Q and R produce laminates having very similar properties with the laminate prepared using varnish Q having slightly superior properties in some instances.

### Example Glossary

PPO: Polyphenylene oxide, same as PPE (Polyphenylene ether)
TAO: Triallyl cyanurate
TAIC: Triallyl isocyanurate
Dicup: Dicumyl peroxide
DYBP: 2,5-Di(tert-butylperoxy)-2,5-dimethyl-3-hexyne
T-260: A test method to check how long a laminate fails at 260 C (minute)
T-288:A test method to check how long a laminate fails at 288 C (minute)
VLP: Very low profile (copper foil)

What is claimed is:

1. A varnish composition comprising:
a polymer selected from the group consisting of polyphenylene ether, polyphenylene oxide and combinations thereof;
at least on reactive monomer;
at least one initiator.

2. The varnish composition of claim 1 wherein the polymer is polyphenylene ether having the formula: 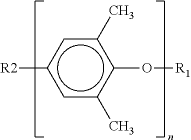
wherein R₁ and R₂ can each be hydrogen, methacrylate or acrylate group and n is an integer ranging from 1 to 100.

3. The varnish composition of claim 1 wherein the polymer is polyphenylene oxide having the following general formula: 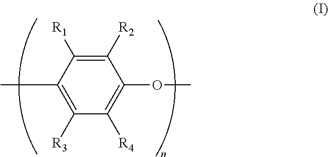
Where R₁, R₂, R₃ and R₄ may be individually selected from hydrogen and a C₁ to C₄ alkyl group wherein n is an integer ranging from 1 to 100.

4. The varnish composition of claim 3 wherein the polyphenylene oxide is selected from: 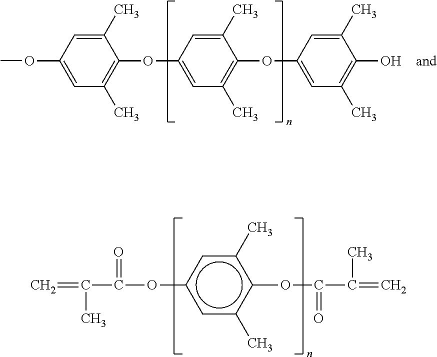
and mixtures thereof wherein n is 1 to 100.

5. The varnish composition of claim 1 wherein the polymer is present in the varnish in an amount ranging from about 25 to about 75 wt % on a dry weight basis.

6. The varnish composition of claim 1 wherein the polymer is present in the varnish in an amount ranging from about 30 to about 60 wt % on a dry weight basis.

7. The varnish composition of claim 1 wherein the reactive monomer is selected from the group of reactive monomers consisting of styrene, bromo-styrene, dibromostyrene, divinylbenzene, pentabromobenzyl acrylate, trivinylcyclohexane, triallyl isocyanurate, triallyl cyanurate, triacrylate isocyanurate and combinations thereof.

8. The varnish composition of claim 1 wherein the reactive monomer is selected from triallyl isocyanurate, triallyl cyanurate and mixtures thereof.

9. The varnish composition of claim 1 wherein the reactive monomer is present in the varnish in an amount ranging from about greater than 0 to about 40 wt % on a dry basis.

10. The varnish composition of claim 1 wherein the reactive monomer is present in the varnish composition in an amount ranging from about 15 to about 35 wt % on a dry basis.

11. The varnish composition of claim 1 wherein the reactive monomer is a copolymer of dibromostyrene and triallyl cyanurate.

12. The varnish composition of claim 11 wherein the copolymer is present in the varnish in an amount ranging from about 15 to about 60 wt %.

13. The varnish composition of claim 1 including one or more flame retardants in an amount ranging from about 5% to about 50 wt % on a dry basis.

14. The varnish composition of claim 13 wherein the flame retardant is one or more halogen free flame retardants.

15. The varnish composition of claim 14 wherein the one or more halogen free flame retardants is selected from the group of compounds consisting of: 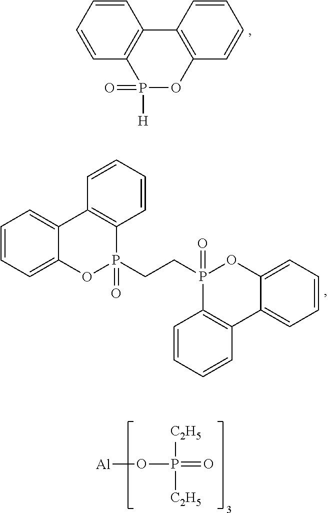
and mixtures thereof.

16. The varnish composition of claim 13 wherein the flame retardant is pentabromobenzyl acrylate.

17. The varnish composition of claim 13 wherein the flame retardant is Decabromodiphenylethane.

18. The varnish composition of claim 1 wherein the initiator is a peroxide initiator selected from the group consisting of benzoyl peroxide, dicumyl peroxide, 2,5-Dimethyl-2,5-di-t-butylperoxyhexyne, 2,5-Dimethyl-2,5-di-t-butylperoxyhexane and combinations thereof where the initiator is present in the varnish in an amount ranging from about 0.5 to about 3.0 wt %.

19. A varnish composition comprising:
from about 30 to about 60 wt % of at least one polyphenylene oxide polymer having the following formula: 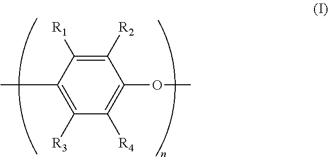
where R₁, R₂, R₃ and R₄ may be individually selected from hydrogen and a C₁ to C₄ alkyl group wherein n is an integer ranging from 1 to 100;
from about 15 to about 35 wt % triallyl cyanurate;
from about 0.5 to about 3 wt % of at least one initiator selected from the group consisting of benzoyl peroxide, dicumyl peroxide, 2,5-Dimethyl-2,5-di-t-butylperoxyhexyne, 2,5-Dimethyl-2,5-di-t-butylperoxyhexane and combinations thereof;
from about 5 to about 50 wt % of at least one flame retardant selected from 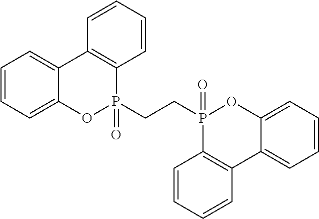 [SMILES: O=P1(CCP2(=O)Oc3ccccc3-c3ccccc32)Oc2ccccc2-c2ccccc21]
and decabromodiphenyl ethane; and
from greater than 0 to about 30 wt % of at least one silica filler.

20. The varnish composition of claim 19 wherein the polyphenylene oxide is selected from: 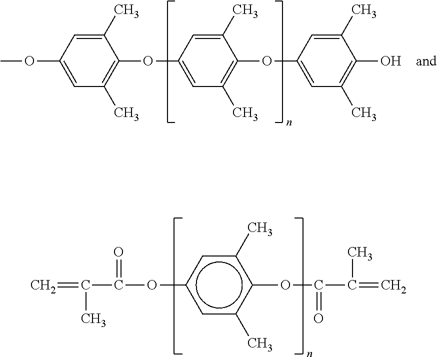
and mixtures thereof wherein n is 1 to 100.

21. The varnish composition of claim 19 wherein the initiator is present in the varnish in an amount ranging from about 1% to 2% based upon 100% of reactive component.

22. The varnish composition of claim 19 wherein the weight ratio of the polyphenylene oxide polymer to triallyl cyanurate ranges from 1.0 to 3.0.

23. A copper sheet having a first surface and second surface wherein the first surface includes a b-staged layer of the varnish of claim 1.

24. A prepreg comprising a core material that is impregnated with an at least partially cured varnish wherein the varnish is an admixture of: a polymer selected from the group consisting of polyphenylene ether, polyphenylene oxide and combinations thereof;
at least on reactive monomer;
at least one initiator.

25. The prepreg of claim 24 wherein the polymer is polyphenylene ether having the formula: 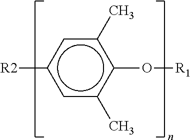
wherein R₁ and R₂ can each be hydrogen, methacrylate or acrylate group and n is an integer ranging from 1 to 100.

26. The prepreg of claim 24 wherein the polymer is polyphenylene oxide having the following general formula: 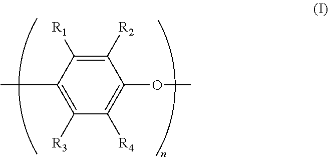
Where R₁, R₂, R₃ and R₄ may be individually selected from hydrogen and a C₁ to C₄ alkyl group wherein n is an integer ranging from 1 to 100.

27. The prepreg of claim 26 wherein the polyphenylene oxide is selected from: 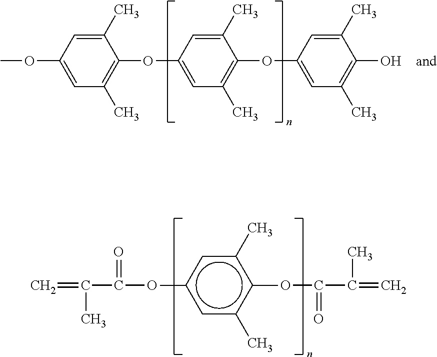
and mixtures thereof wherein n is 1 to 100.

28. The prepreg of claim 24 wherein the polymer is present in the varnish in an amount ranging from about 25 to about 75 wt % on a dry weight basis.

29. The prepreg of claim 24 wherein the polymer is present in the varnish in an amount ranging from about 30 to about 60 wt % on a dry weight basis.

30. The prepreg of claim 24 wherein the reactive monomer is selected from the group of reactive monomers consisting of styrene, bromo-styrene, dibromostyrene, divinylbenzene, pentabromobenzyl acrylate, trivinylcyclohexane, triallyl isocyanurate, triallyl cyanurate, triacrylate isocyanurate and combinations thereof.

31. The prepreg of claim 24 wherein the reactive monomer is selected from triallyl isocyanurate, triallyl cyanurate and mixtures thereof.

32. The prepreg of claim 24 wherein the reactive monomer is present in the varnish in an amount ranging from about greater than 0 to about 40 wt % on a dry basis.

33. The prepreg of claim 23 wherein the reactive monomer is present in the varnish composition in an amount ranging from about 15 to about 35 wt % on a dry basis.

34. The prepreg of claim 24 wherein the reactive monomer is a copolymer of dibromostyrene and triallyl cyanurate.

35. The prepreg of claim 34 wherein the copolymer is present in the varnish in an amount ranging from about 15 to about 60 wt %.

36. The prepreg of claim 24 including one or more flame retardants in an amount ranging from about 5% to about 50 wt % on a dry basis.

37. The prepreg of claim 36 wherein the flame retardant is one or more halogen free flame retardants.

38. The prepreg of claim 37 wherein the one or more halogen free flame retardants is selected from the group of compounds consisting of: 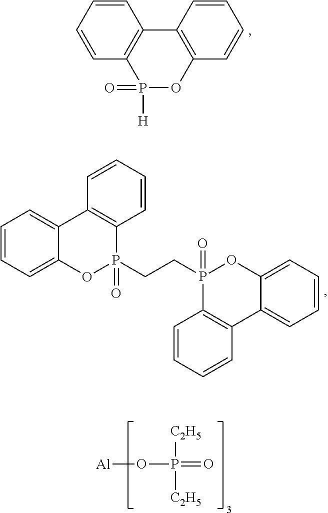
and mixtures thereof.

39. The prepreg of claim 36 wherein the flame retardant is pentabromobenzyl acrylate.

40. The prepreg of claim 36 wherein the flame retardant is Decabromodiphenylethane.

41. The prepreg of claim 24 wherein the initiator is a peroxide initiator selected from the group consisting of benzoyl peroxide, dicumyl peroxide, 2,5-Dimethyl-2,5-d i-t-butylperoxyhexyne, 2,5-Dimethyl-2,5-di-t-butylperoxyhexane and combinations thereof where the initiator is present in the varnish in an amount ranging from about 0.5 to about 3.0 wt %.

42. A prepreg comprising a core material that is impregnated with an at least partially cured varnish wherein the varnish is an admixture of:
from about 30 to about 60 wt % of at least one polyphenylene oxide polymer having the following formula: 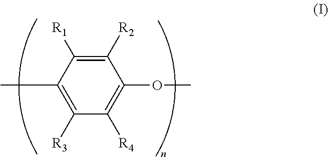
where R₁, R₂, R₃ and R₄ may be individually selected from hydrogen and a C₁ to C₄ alkyl group wherein n is an integer ranging from 1 to 100;
from about 15 to about 35 wt % triallyl cyanurate;
from about 0.5 to about 3 wt % of at least one initiator selected from the group consisting of benzoyl peroxide, dicumyl peroxide, 2,5-Dimethyl-2,5-di-t-butylperoxyhexyne, 2,5-Dimethyl-2,5-di-t-butylperoxyhexane and combinations thereof;
from about 5 to about 50 wt % of at least one flame retardant selected from 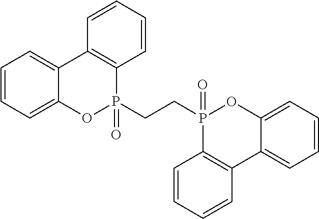 [SMILES: O=P1(CCP2(=O)Oc3ccccc3-c3ccccc32)Oc2ccccc2-c2ccccc21]
and decabromodiphenyl ethane; and
from greater than 0 to about 30 wt % of at least one silica filler.

43. The prepreg of claim 42 wherein the polyphenylene oxide is selected from: 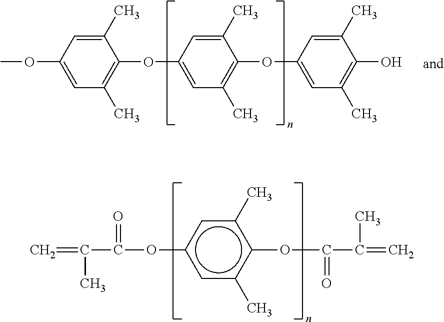
and mixtures thereof wherein n is 1 to 100.

44. The prepreg of claim 42 wherein the initiator is present in the varnish in an amount ranging from about 1% to 2% based upon 100% of reactive component.

45. The prepreg of claim 42 wherein the weight ratio of the polyphenylene oxide polymer to triallyl cyanurate ranges from 1.0 to 3.0.

46. The prepreg of claim 24 or 42 wherein the varnish is c-staged.

47. A laminate including one or more prepregs of claim 24 or 42.
